(19) United States
(12) Patent Application Publication
(10) Pub. No.: US 2025/0057237 A1
(43) Pub. Date: Feb. 20, 2025

(54) AEROSOL PROVISION DEVICE

(71) Applicant: NICOVENTURES TRADING LIMITED, London (GB)

(72) Inventors: Damyn MUSGRAVE, London (GB); Zhihuang XIAO, London (GB); Daniel BALL, London (GB)

(21) Appl. No.: 18/723,445

(22) PCT Filed: Dec. 21, 2022
(86) PCT No.: PCT/EP2022/087373

§ 371 Date: Jun. 23, 2024

(30) Foreign Application Priority Data
Dec. 24, 2021 (GB) 2119026.9

(51) Int. Cl. A24F 40/465; A24F 40/57; H05B 6/10

(52) U.S. Cl. CPC A24F 40/465; A24F 40/57; H05B 6/108

(57) ABSTRACT

An aerosol provision device includes an aerosol generator having an inductor including a plurality of discrete ring electrodes mounted to a first substrate.

### RELATED APPLICATIONS

The present application is a National Phase entry of PCT Application No. PCT/EP2022/087373 filed Dec. 21, 2022, which claims priority to GB Application No. 2119026.9 filed Dec. 24, 2021, each of which is hereby incorporated by reference in their entirety.

### TECHNICAL FIELD

The present invention relates to a component of an aerosol provision device, an aerosol generator, an aerosol provision device, an aerosol generating system and a method of generating an aerosol.

### BACKGROUND

Smoking articles such as cigarettes, cigars and the like burn tobacco during use to create tobacco smoke. Attempts have been made to provide alternatives to these articles by creating products that release compounds without combusting. Examples of such products are so-called “heat not burn” products or tobacco heating devices or products, which release compounds by heating, but not burning, material. The material may be, for example, tobacco or other non-tobacco products, which may or may not contain nicotine.

Aerosol provision systems, which cover the aforementioned devices or products, are known. Common systems use heaters to create an aerosol from a suitable medium which is then inhaled by a user. Often the medium used needs to be replaced or changed to provide a different aerosol for inhalation. It is known to use induction heating systems as heaters to create an aerosol from a suitable medium. An induction heating system generally consists of a magnetic field generating device for generating a varying magnetic field, and a susceptor or heating material which is heatable by penetration with the varying magnetic field to heat the suitable medium.

Known magnetic field generating devices include inductive coils. An inductive coil may be formed with a suitable geometry for achieving the desired heating of the material. This can be achieved by winding a suitable material, such as a LITZ® wire, into the desired coil shape. However, the shape (e.g. pitch) of the coil may be unintentionally altered as the device is assembled, which can prevent the desired heating of the material from being achieved.

### SUMMARY

According to an aspect there is provided an aerosol provision device comprising:
an aerosol generator comprising an inductor comprising a plurality of discrete ring electrodes mounted to a first substrate.

According to various embodiments an inductor is provided comprising a plurality of ring electrodes which can either be controlled individually or which can be grouped into one or more groups of electrodes. The ring electrodes can be mounted to a substrate such as a printed circuit board in a compact and robust manner.

Optionally, the first substrate comprises a first printed circuit board (“PCB”). According to various embodiments the first substrate may comprise a plurality of printed circuit boards.

Optionally, the ring electrodes are planar.

Optionally, the ring electrodes comprise an electrically conductive material.

Optionally, the ring electrodes comprise copper or other conductive metal.

Optionally, the ring electrodes have a rectangular, circular or polygonal cross-sectional profile.

Optionally, the ring electrodes are embedded in a matrix to form a housing.

Optionally, the matrix or housing comprises polyetheretherketone (“PEEK”) or equivalent high temperature plastic material.

Optionally, portions of the ring electrodes extend beyond the housing to form electrical connectors.

Optionally, the electrical connectors are soldered or secured to the first substrate.

Optionally, the first substrate comprises one or more connectors or pads for electrically connecting the first substrate to a second substrate.

Optionally, the second substrate comprises a second printed circuit board (“PCB”).

Optionally, the plurality of discrete ring electrodes comprise 5, 6, 7, 8, 9, 10, 11, 12, 13, 14, 15, 16, 17, 18, 19, 20 or more than 20 electrodes.

Optionally, the plurality of ring electrodes are arranged co-axially.

Optionally, the plurality of ring electrodes are equally spaced axially.

Optionally, the plurality of ring electrodes are grouped into at least a first group of ring electrodes and a second group of ring electrodes.

Other embodiments are contemplated wherein the plurality of ring electrodes are grouped into a first group of ring electrodes and one or more further groups of ring electrodes.

Optionally, the first group of ring electrodes have a first axial spacing S1 and the second group of ring electrodes have a second different axial spacing S2. According to an embodiment the first axial spacing S1 may be <1 mm, 1-2 mm, 2-3 mm, 3-4 mm, 4-5 mm, 5-6 mm, 6-7 mm, 7-8 mm, 8-9 mm, 9-10 mm or >10 mm. Similarly, according to an embodiment the second axial spacing S2 may be <1 mm, 1-2 mm, 2-3 mm, 3-4 mm, 4-5 mm, 5-6 mm, 6-7 mm, 7-8 mm, 8-9 mm, 9-10 mm or >10 mm.

Optionally, the first group of ring electrodes have a first cross sectional profile and the second group of ring electrodes have a second different cross sectional profile.

Optionally, the aerosol provision device further comprises a control device arranged to supply a first voltage V1 to the first group of ring electrodes and a second different voltage V2 to the second group of ring electrodes. According to various embodiment the ratio V1/V2 may be in the range <0.5, 0.5-0.6, 0.6-0.7, 0.7-0.8, 0.8-0.9, 0.9-1.0, 1.0-1.1, 1.1-1.2, 1.2-1.3, 1.3-1.4, 1.4-1.5 or >1.5. The voltages V1 and V2 comprise AC voltages.

According to another aspect there is provided an aerosol generating system comprising:
an aerosol provision device as described above; and
an aerosol generating article.

According to another aspect there is provided a method of generating an aerosol comprising:
inserting an aerosol generating article within an inductor comprising a plurality of discrete ring electrodes mounted to a first substrate; and
energising the inductor.

According to another aspect there is provided an aerosol provision device comprising:
an aerosol generator comprising a plurality of ring electrodes; and
a control device arranged to independently apply one or more AC voltages to either individual ring electrodes and/or to groups of ring electrodes.

According to another aspect there is provided an aerosol generating system comprising:
an aerosol provision device as described above; and
an aerosol generating article.

According to another aspect there is provided a method of generating an aerosol comprising:
providing an aerosol generator comprising a plurality of ring electrodes;
inserting an aerosol generating article into the aerosol generator; and
independently applying an AC voltage to either individual ring electrodes and/or to groups of ring electrodes.

According to an aspect there is provided an aerosol provision device comprising:
an aerosol generator comprising a plurality of ring electrodes, wherein the ring electrodes are arranged to form a plurality of independently controllable heating zones; and
a control device arranged to independently energise the ring electrodes so that a heating profile is translated along at least a portion of the length of the aerosol generator during a session of use.

The session of use may last <3 mins, 3-4 mins, 4-5 mins, 5-6 mins or >6 mins.

Optionally, the control device is arranged to apply an AC voltage to either individual ring electrodes and/or groups of ring electrodes in a sequential manner or according to a predetermined order.

Optionally, the aerosol provision device comprises an opening for receiving an aerosol generating article, wherein a first heating zone is arranged proximal the opening and a second heating zone is arranged distal to the opening and wherein the control device is arranged either: (i) to translate the heating profile from the first heating zone towards the second heating zone during a session of use; and/or (ii) to translate the heating profile from the second heating zone towards the first heating zone during a session of use.

According to an aspect there is provided a method of generating an aerosol comprising:
providing a plurality of ring electrodes, wherein the ring electrodes are arranged to form a plurality of independently controllable heating zones;
inserting an aerosol generating article into the heating zones; and
independently energising the ring electrodes so that a heating profile is translated along at least a portion of the length of the aerosol generator during a session of use.

According to an aspect there is provided a component of an aerosol provision device comprising:
an inductor element comprising a plurality of discrete ring electrodes mounted to a substrate;
a first module arranged to receive a DC voltage and to output an alternating current; and
a second module arranged to supply the alternating current to selected ring electrodes.

According to another aspect there is provided a component of an aerosol provision device comprising:
an inductor element comprising a plurality of discrete ring electrodes mounted to a substrate; and
a module arranged to supply an alternating current to selected ring electrodes.

Optionally, the second module comprises a plurality of electronic switching elements. The electronic switching elements may comprise a switching arrangement comprising e.g. a pair of MOSFETs.

Optionally, at least one electronic switching element is connected to at least some of the ring electrodes.

Optionally, at least some of the switching elements are independently controllable so that the alternating current output from the first module may be applied to selected ring electrodes.

Optionally, at least some or each of the switching elements comprise a half-bridge circuit.

Optionally, at least some or each half-bridge circuit comprises two MOSFETs.

According to another aspect there is provided an aerosol generator of an aerosol provision device comprising:
a component as described above.

According to another aspect there is provided an aerosol provision device comprising:
an aerosol generator as described above.

Optionally, the alternating current supplied to one or more ring electrodes causes a varying magnetic field to be generated.

Optionally, the aerosol provision device further comprises a controller, wherein the controller is arranged to control the second module in order to control which ring electrodes are supplied with the alternating current.

Optionally, the aerosol provision device further comprises a tubular susceptor located at least partially within a volume defined by the plurality of ring electrodes.

Optionally, the tubular susceptor comprises one or more circumferential slots.

Optionally, the tubular susceptor comprises a plurality of annular susceptor portions, wherein at least some of the annular susceptor portions are separated from each by one or more thermal barrier portions.

According to an alternative embodiment a susceptor element may be provided as part of an aerosol generating article (i.e. consumable) and hence may not form part of the aerosol provision device.

According to another aspect there is provided an aerosol provision system comprising:
an aerosol provision device as described above; and
an aerosol generating article.

The aerosol generating article comprises aerosol generating material.

According to another aspect there is provided a method of generating an aerosol comprising:
providing an aerosol provision device as described above;
at least partially inserting an aerosol generating article into the aerosol provision device; and
activating the aerosol provision device.

### BRIEF DESCRIPTION OF THE DRAWINGS

FIG. 1 shows an aerosol provision device according to an embodiment, wherein the aerosol provision device comprises an inductor formed from a plurality of discrete ring electrodes mounted to a first substrate which comprises a printed circuit board and a tubular susceptor element;

FIG. 2 shows an aerosol generator according to an embodiment comprising an inductor element comprising a plurality of ring electrodes mounted to a first substrate which comprises a printed circuit board and a tubular susceptor element located within a volume defined by the ring electrodes;

FIG. 3 shows a cross sectional view of an aerosol generator according to an embodiment comprising an inductor element comprising a plurality of ring electrodes mounted to a first substrate which comprises a printed circuit board and a tubular susceptor element located within a volume defined by the ring electrodes;

FIG. 4 shows a side view of the aerosol generator according to an embodiment and shows connector portions of the ring electrodes extending through a rear surface of a printed circuit board;

FIG. 5 shows a side view of an aerosol generator according to an embodiment and shows a thermocouple connected to the susceptor element;

FIG. 6 shows a cross-sectional view of an aerosol generator according to an embodiment and shows two groups of ring electrodes embedded in a housing;

FIG. 7 shows a first substrate comprising a plurality of electrical connections which are arranged into two groups so that ring electrodes which are connected to the electrical connections are grouped into a first group of ring electrodes and a second group of ring electrodes;

FIG. 8 shows in greater detail a first substrate and two groups of electrical connections provided thereon;

FIG. 9 shows a control device provided on a second substrate which is connected to the first substrate and wherein ring electrodes which are connected to the electrical connections provided on the first substrate are grouped into two groups of ring electrodes;

FIG. 10 shows a schematic of an electronic component of an aerosol provision device wherein the component comprises an inductor element comprising a plurality of discrete ring electrodes, a first module for converting a DC voltage into an AC voltage and a second module comprising a plurality of semiconductor switches (e.g. MOSFETs) which are arranged to independently select which ring electrodes are supplied with an AC voltage;

FIG. 11 shows a schematic of an electrical arrangement of a component of an aerosol provision device, wherein the electrical arrangement may be used to apply an AC voltage to a group of ring electrodes;

FIG. 12 shows a schematic of an electrical arrangement for a component of an aerosol provision device, wherein the electrical arrangement may be used to apply an AC voltage to a group of five ring electrodes L1-L5;

FIG. 13 illustrates an aerosol generator according to an embodiment comprising six ring electrodes mounted to a printed circuit board (“PCB”) and a susceptor element located within a volume defined by the ring electrodes, wherein one or more circumferential slots may be provided in the susceptor element in order to reduce thermal bleed from one section of the susceptor element to an adjacent section of the susceptor element; and

FIG. 14 illustrates the direction of flow of current around multiple ring electrodes according to an embodiment and the resulting magnetic field.

### DETAILED DESCRIPTION

Aspects and features of certain examples and embodiments are discussed or described herein. Some aspects and features of certain examples and embodiments may be implemented conventionally and these are not discussed or described in detail in the interests of brevity. It will thus be appreciated that aspects and features of apparatus and methods discussed herein which are not described in detail may be implemented in accordance with conventional techniques for implementing such aspects and features.

According to the present disclosure, a “non-combustible” aerosol provision system is one where a constituent aerosol-generating material of the aerosol provision system (or component thereof) is not combusted or burned in order to facilitate delivery of at least one substance to a user.

In some embodiments, the delivery system is a non-combustible aerosol provision system, such as a powered non-combustible aerosol provision system.

In some embodiments, the non-combustible aerosol provision system is an electronic cigarette, also known as a vaping device or electronic nicotine delivery system (END), although it is noted that the presence of nicotine in the aerosol-generating material is not a requirement.

In some embodiments, the non-combustible aerosol provision system is an aerosol-generating material heating system, also known as a heat-not-burn system. An example of such a system is a tobacco heating system.

In some embodiments, the non-combustible aerosol provision system is a hybrid system to generate aerosol using a combination of aerosol-generating materials, one or a plurality of which may be heated. Each of the aerosol-generating materials may be, for example, in the form of a solid, liquid or gel and may or may not contain nicotine. In some embodiments, the hybrid system comprises a liquid or gel aerosol-generating material and a solid aerosol-generating material. The solid aerosol-generating material may comprise, for example, tobacco or a non-tobacco product.

Typically, the non-combustible aerosol provision system may comprise a non-combustible aerosol provision device and a consumable for use with the non-combustible aerosol provision device.

In some embodiments, the disclosure relates to consumables comprising aerosol-generating material and configured to be used with non-combustible aerosol provision devices. These consumables are sometimes referred to as articles throughout the disclosure.

In some embodiments, the non-combustible aerosol provision system, such as a non-combustible aerosol provision device thereof, may comprise a power source and a controller. The power source may, for example, be an electric power source or an exothermic power source. In some embodiments, the exothermic power source comprises a carbon substrate which may be energised so as to distribute power in the form of heat to an aerosol-generating material or to a heat transfer material in proximity to the exothermic power source.

In some embodiments, the non-combustible aerosol provision system may comprise an area for receiving the consumable, an aerosol generator, an aerosol generation area, a housing, a mouthpiece, a filter and/or an aerosol-modifying agent.

In some embodiments, the consumable for use with the non-combustible aerosol provision device may comprise aerosol-generating material, an aerosol-generating material storage area, an aerosol-generating material transfer component, an aerosol generator, an aerosol generation area, a housing, a wrapper, a filter, a mouthpiece, and/or an aerosol-modifying agent.

Aerosol-generating material is a material that is capable of generating aerosol, for example when heated, irradiated or energized in any other way. Aerosol-generating material may, for example, be in the form of a solid, liquid or semi-solid (such as a gel) which may or may not contain an active substance and/or flavorants.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In particular, in some embodiments, the aerosol-generating material is substantially tobacco free.

The aerosol-generating material may comprise or be an aerosol-generating film. The aerosol-generating film may be formed by combining a binder, such as a gelling agent, with a solvent, such as water, an aerosol-former and one or more other components, such as active substances, to form a slurry and then heating the slurry to volatilize at least some of the solvent to form the aerosol-generating film. The slurry may be heated to remove at least about 60 wt %, 70 wt %, 80 wt %, 85 wt % or 90 wt % of the solvent. The aerosol-generating film may be a continuous film or a discontinuous film, such an arrangement of discrete portions of film on a support. The aerosol-generating film may be substantially tobacco free.

The aerosol-generating film may comprise or be a sheet, which may optionally be shredded to form a shredded sheet.

The aerosol-generating material may comprise one or more active substances and/or flavors, one or more aerosol-former materials, and optionally one or more other functional material.

An aerosol generator is an apparatus configured to cause aerosol to be generated from the aerosol-generating material. In some embodiments, the aerosol generator is a heater configured to subject the aerosol-generating material to heat energy, so as to release one or more volatiles from the aerosol-generating material to form an aerosol. In some embodiments, the aerosol generator is configured to cause an aerosol to be generated from the aerosol-generating material without heating. For example, the aerosol generator may be configured to subject the aerosol-generating material to one or more of vibration, increased pressure, or electrostatic energy.

A consumable is an article comprising or consisting of aerosol-generating material, part or all of which is intended to be consumed during use by a user. A consumable may comprise one or more other components, such as an aerosol generating material storage area, an aerosol-generating material transfer component, an aerosol generation area, a housing, a wrapper, a mouthpiece, a filter and/or an aerosol-modifying agent. A consumable may also comprise an aerosol generator, such as a heater, that emits heat to cause the aerosol-generating material to generate aerosol in use. The heater may, for example, comprise combustible material, a material heatable by electrical conduction, or a susceptor.

A susceptor is a heating material that is heatable by penetration with a varying magnetic field, such as an alternating magnetic field. The susceptor may be an electrically-conductive material, so that penetration thereof with a varying magnetic field causes induction heating of the heating material. The heating material may be magnetic material, so that penetration thereof with a varying magnetic field causes magnetic hysteresis heating of the heating material. The susceptor may be both electrically-conductive and magnetic, so that the susceptor is heatable by both heating mechanisms. The aerosol provision device that is configured to generate the varying magnetic field is referred to as a magnetic field generator, herein.

Non-combustible aerosol provision systems may comprise a modular assembly including both a reusable aerosol provision device and a replaceable aerosol generating article. In some implementations, the non-combustible aerosol provision device may comprise a power source and a controller (or control circuitry). The power source may, for example, comprise an electric power source, such as a battery or rechargeable battery. In some implementations, the non-combustible aerosol provision device may also comprise an aerosol generating component. However, in other implementations the aerosol generating article may comprise partially, or entirely, the aerosol generating component.

Induction heating is a process in which an electrically-conductive object, referred to as a susceptor, is heated by penetrating the object with a varying magnetic field. The process is described by Faraday's law of induction and Ohm's law. An induction heater may comprise an electromagnet and a device for passing a varying electrical current, such as an alternating current, through the electromagnet. When the electromagnet and the object to be heated are suitably relatively positioned so that the resultant varying magnetic field produced by the electromagnet penetrates the object, one or more eddy currents are generated inside the object. The object has a resistance to the flow of electrical currents and when such eddy currents are generated in the object, their flow against the electrical resistance of the object causes the object to be heated. This process is called Joule, ohmic or resistive heating.

Magnetic hysteresis heating is a process in which an object made of a magnetic material is heated by penetrating the object with a varying magnetic field. A magnetic material can be considered to comprise many atomic-scale magnets, or magnetic dipoles. When a magnetic field penetrates such material, the magnetic dipoles align with the magnetic field. Therefore, when a varying magnetic field, such as an alternating magnetic field, for example as produced by an electromagnet, penetrates the magnetic material, the orientation of the magnetic dipoles changes with the varying applied magnetic field. Such magnetic dipole reorientation causes heat to be generated in the magnetic material.

When an object is both electrically-conductive and magnetic, penetrating the object with a varying magnetic field can cause both Joule heating and magnetic hysteresis heating in the object. Moreover, the use of magnetic material can strengthen the magnetic field, which can intensify the Joule heating.

Various embodiments will now be described in more detail.

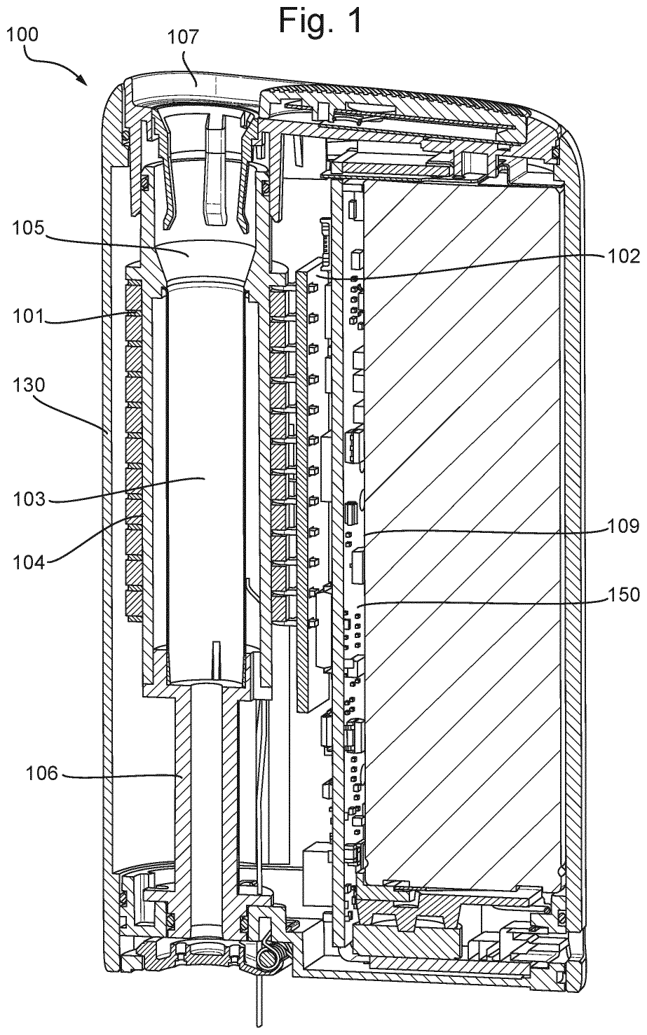

FIG. 1 shows an aerosol provision device 100 according to an embodiment. The aerosol provision device 100 comprises an outer housing 130 and an inductor or inductive heating element comprising a plurality of ring electrodes 101 arranged around a heating chamber housing 104. A susceptor 103 is provided within the heating chamber housing 104 and a heating chamber is formed within the susceptor 103. The susceptor 103 may be tubular. A lid or slidable cover 107 may be provided at the entrance to the heating chamber. An aerosol generating article comprising aerosol generating material may be inserted via the lid or slidable cover 107 into the heating chamber and may be surrounded by at least a portion of the susceptor 103.

It will be understood that the susceptor 103 will become hot due to interacting with a magnetic field emitted by the inductor or inductive heating element comprising a plurality of ring electrodes 101. As a result, an aerosol generating article located within the susceptor 103 will become heated.

The inductor or inductive heating element according to various embodiments comprises a plurality of ring electrodes 101 mounted to a first substrate 102. The first substrate 102 may comprise a printed circuit board (“PCB”). According to various embodiments the inductor or inductive heating element may comprise 2, 3, 4, 5, 6, 7, 8, 9, 10, 11, 12, 13, 14, 15, 16, 17, 18, 19, 20 or more than 20 ring electrodes 101.

The susceptor 103 is located within the heating chamber housing 104 and may be mounted between an upper portion 105 of the heater chamber housing 104 and a cleanout tube 106. According to various embodiments the susceptor 103 may be held in compression between the upper portion 105 of the heater chamber housing 104 and the cleanout tube 106. It should be understood that reference to being held in compression relates to the location of the susceptor 103 rather than the susceptor 103 being subjected to a high compressive force.

The susceptor 103 comprises a heating material that is heatable by penetration with a varying magnetic field, such as an alternating magnetic field. The susceptor 103 may comprise an electrically conductive material, so that penetration thereof with a varying magnetic field causes induction heating of the heating material. The heating material may be magnetic material, so that penetration thereof with a varying magnetic field causes magnetic hysteresis heating of the heating material. The susceptor 103 may be both electrically conductive and magnetic, so that the susceptor 103 is heatable by both heating mechanisms. The susceptor 103 may comprise a ferroelectric and/or ferromagnetic material.

An aerosol generating article may be inserted through the entrance to the heating chamber which is formed by the susceptor 103. The aerosol generating article may be received within the heating chamber such that the aerosol generating article is in thermal communication with the susceptor 103. Accordingly, when the susceptor 103 is inductively heated, the susceptor 103 may conduct heat to the aerosol generating article and thereby causing an aerosol to be generated from aerosol generating material which comprises the aerosol generating article.

A control device 109 may be provided on a second substrate 150 (which may also comprise a printed circuit board) and may be connected to the first substrate 109 via one or more electrical connections. The control device 109 may be arranged to apply an AC voltage to the ring electrodes 101 in order to generate a time varying magnetic field. The time varying magnetic field will cause the heating material of the susceptor 103 to be heated.

According to an embodiment the control device 109 may be configured to independently apply an AC voltage to individual ring electrodes 101. Alternatively, the control device 109 may be arranged to apply an AC voltage to groups of ring electrodes 101. It will be understood that passing an alternating current through each of the ring electrodes 101 will generate an alternating magnetic field which will cause a corresponding region of the susceptor 103 to be heated.

As shown in FIG. 1, the control device 109 may be provided on a second substrate 150 which is separate to the first substrate 102 to which the ring electrodes 101 are mounted. However, other embodiments are contemplated wherein all or part of the components of the control device 109 may be located on the same first substrate 102 that the ring electrodes 101 are mounted to.

According to various embodiments the first substrate 102 and the second substrate 150 may comprise printed circuit boards (PCBs). The first substrate 102 or printed circuit board may comprise one or more connectors or pads on a rear surface of the first substrate 102 which may be arranged to connect electrically with corresponding connectors or pads provided on a front surface of the second substrate 150 or printed circuit board.

Embodiments are contemplated wherein the control device 109 may be located on a different substrate 150 to that of the first substrate 102 to which the ring electrodes 101 are mounted and wherein a wireless connection may be made between the first substrate 102 and the other substrate 150.

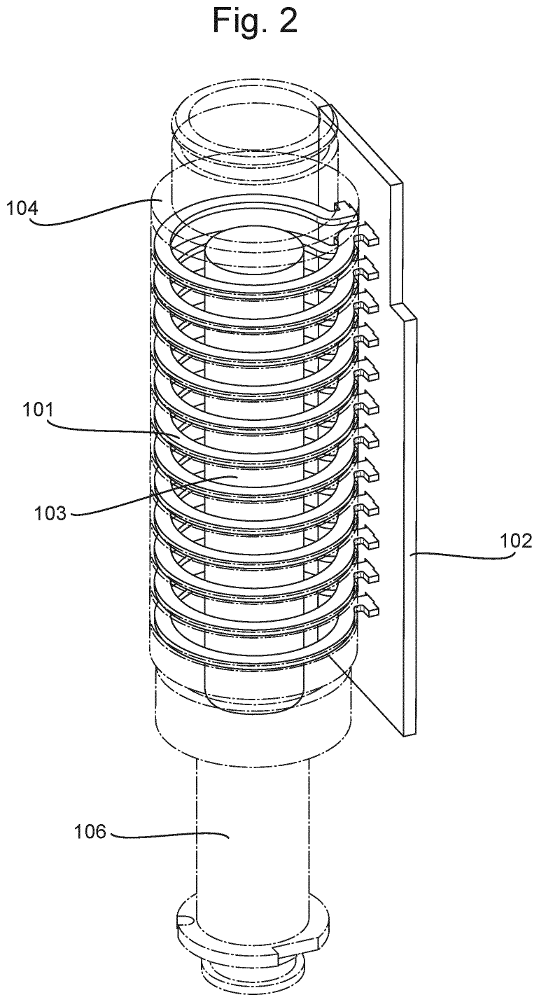

FIG. 2 shows in greater detail an inductor or inductive heating element according to an embodiment wherein the inductor or inductive heating element comprises a plurality of discrete ring electrodes 101 mounted to a first substrate 102. According to the particular embodiment shown in FIG. 2 twelve ring electrodes 101 are mounted to the first substrate 102. However, it will be appreciated that according to other embodiments a different number of ring electrodes 101 may be mounted to the first substrate 102. The inductor or inductive heating element according to various embodiments comprising a plurality of discrete ring electrodes 101 can allow for different desired inductor geometries to be easily constructed. For example, the number of ring electrodes 101 can be varied and/or the separation distance between the ring electrodes 101 can be varied. This enables different heating profiles to be achieved. A tubular susceptor element 103 may be located within a volume inscribed by the ring electrodes 103.

According to various embodiments the ring electrodes 101 may comprise rigid electrodes with the result that when the ring electrodes 101 are provided on the first substrate 102 a robust inductor or inductive heating element may be provided. It will be appreciated, therefore, that according to various embodiments an aerosol provision device is provided which is particularly rugged and robust.

Each of the discrete ring electrodes 101 may be provided as a discontiguous or separate element which is mounted to the first substrate 102 and wherein each ring electrode 101 is separate from one another. Each ring electrode 101 may comprise a ring section or portion with an electrical connection portion at each end. The ends of the ring electrodes 101 may comprise electrical connection portions and the electrical connection portions may be attached or otherwise secured to the first substrate 102. Each ring electrode 101 may be electrically connected to, and supported by, the first substrate 102 via the electrical connection portions.

According to various embodiments each ring electrode 101 may comprise two electrical connection portions which allows the ring electrodes 101 to be positioned on the first substrate 102 independently of the other ring electrodes 101 whilst allowing for a suitable electrical connection with the first substrate 102. Each ring electrode 101 may have its own electrical connection to the first substrate 102 independent of the electrical connections of at least some of the other electrodes 101 to the first substrate 102 so as to allow for independent control of particular electrodes(s) 102.

The ring electrodes 101 may be mounted to the first substrate 102 in any suitable manner. In an embodiment, the electrical connection portions and/or the first substrate 102 may be configured and adapted for connection to one another. For example, the electrical connection portions of the ring electrodes 101 and the first substrate 102 may be configured for the electrical connection portions to be inserted into corresponding holes or slots provided in the first substrate 102. Other embodiments are contemplated wherein the electrical connection portions comprise holes or slots configured for attachment to corresponding electrodes provided on the first substrate 102. Fixings such as screws may be used.

According to an embodiment the ring electrodes 101 may be soldered to the first substrate 102. In order to facilitate this, the electrical connection portions may be configured to be soldered into corresponding slots provided in the first substrate 102 which may comprise a printed circuit board. The electrical connection portions may be coated with a material (e.g. gold) to facilitate solder connection to the first substrate 102.

According to various embodiments, insertion of the electrical connection portions into corresponding slots on the first substrate 102 may be sufficient to secure the ring electrodes 101 to the first substrate 102 and to form an electrical connection between the first substrate 102 and the ring electrodes 101. For example, according to various embodiments the ring electrodes 101 may be connected to the first substrate 102 by virtue of an interference fit or snap fit.

An alternating current may be arranged to pass through the ring portions of the electrodes 101 via the electrical connection portions thereby generating a varying magnetic field. It will be understood that the varying magnetic field will cause the susceptor 103 located radially inwards of the ring electrodes 101 to become heated. The susceptor 103 may be located within a volume defined by the internal radius of the ring portions of the ring electrodes 101. One end of the susceptor 103 may be secured to a portion of a heater chamber housing 104. Another end of the susceptor 103 may be secured to a cleanout tube 106.

The ring electrodes 101 may be arranged so as to be co-axial with one another. Each of the ring electrodes 101, or at least the ring portions thereof, may be substantially flat i.e. planar. The ring electrodes 101 may be substantially flat in a plane which is perpendicular to an axial direction of the ring electrodes 101 or a longitudinal axis of the inductor or inductive heating element. The ring electrodes 101 may be aligned with one another when attached to the first substrate 102 such that planar surfaces of the ring electrodes 101 are in parallel planes to one another. Providing planar ring electrodes 101 can allow for localised heating of relatively small portions of the susceptor 103 by each ring electrode 101 thereby enabling accurate control of the temperature distribution along the length of the susceptor 103.

Other embodiments are contemplated wherein the ring electrodes 101 may be non-planar e.g. helical so that relatively fewer electrodes may allow the heating of relatively greater lengths of a susceptor 103. The ring electrodes 101 may be planar with a rectangular, circular or polygonal cross-sectional profile. The ring portions may comprise an electrically-conductive material e.g. copper or gold. It is also contemplated that a conductive track may be provided on one or both planar surfaces of each ring electrode 101 or the ring portion itself may consist (entirely) of electrically-conductive material (e.g. copper). The ring electrodes 101 may be constructed by, for example, being cut from a planar sheet of material, or by an elongate piece of material being bent into the required shape. The ring electrodes 101 are shown mounted to a heater chamber housing 104 which is connected to a cleanout tube 106.

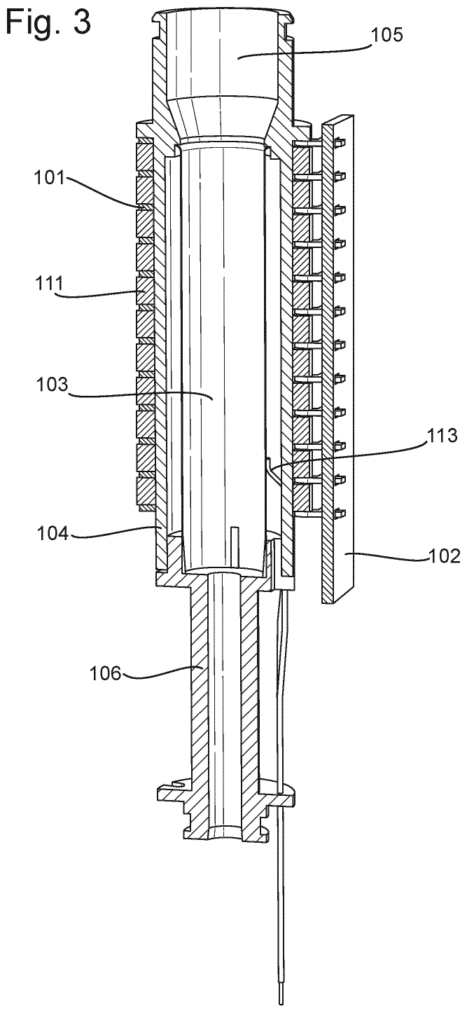

FIG. 3 shows a cross sectional view of an aerosol generator according to various embodiments. The aerosol generator comprises an inductor or inductive heating element comprising a plurality of discrete ring electrodes 101 mounted to a first substrate 102 which may comprise a printed circuit board. The ring electrodes 101 may be mounted around and optionally embedded within a heater chamber housing 104. The aerosol generator further comprises a susceptor 103 located within the heater chamber housing 104.

According to an embodiment the susceptor 103 may be mounted between an upper portion 105 of the heater chamber housing 104 and a cleanout tube 106. The heater chamber housing 104 may be located within the ring portions of the ring electrodes 101 and the susceptor 103 may be located within the heater chamber housing 104.

The electrical connection portions of the ring electrodes 101 may extend beyond the heater chamber housing 104 to allow for connection to the first substrate 102. A plurality of spacers 111 formed of electrically insulating material (e.g. a thermoplastic, such as polyetheretherketone (PEEK)) may be located between the ring electrodes 101. The spacers 111 may have a cross-sectional shape substantially corresponding to the ring portions of the electrodes 101. However, it should be understood that the spacers 111 are optional and the ring electrodes 101 may have sufficient rigidity such as not to require any spacers 111 being provided between the ring electrodes 101. According to various embodiments a temperature sensor 113, such as a thermocouple, may be attached to the susceptor 103 for sensing a temperature of the susceptor 103.

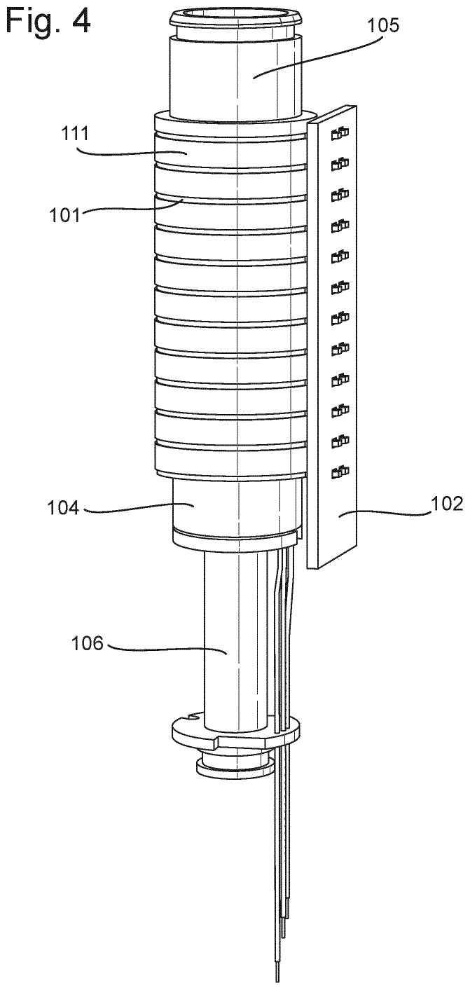

FIG. 4 shows a side view of the ring electrodes 101, spacers 111, the heater chamber housing 104, an upper portion of the heater chamber housing 105, a cleanout tube 106 and a first substrate 102 mounted to electrical connection portions of the ring electrodes 101.

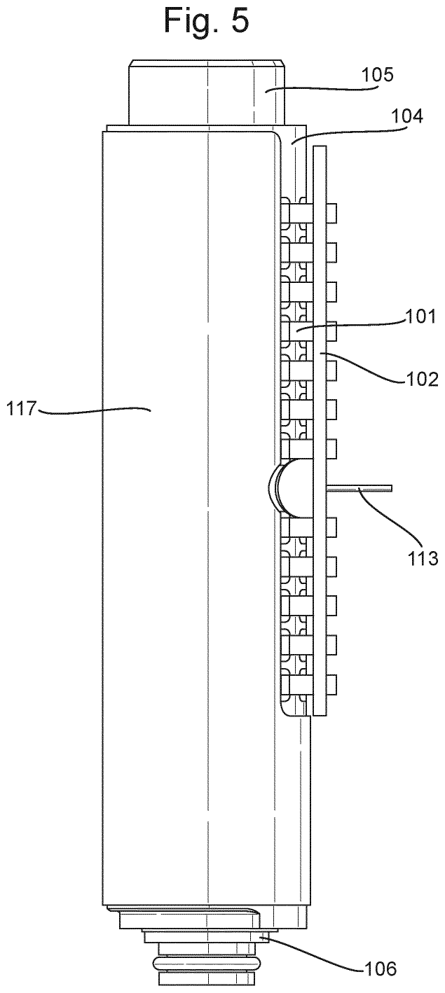

FIG. 5 shows a side view of an aerosol generator according to various embodiments. The aerosol generator comprises an inductor or inductive heating element comprising a plurality of discrete ring electrodes 101 mounted to a first substrate 102 (e.g. a PCB). The aerosol generator further comprises a susceptor (not shown), a heater chamber housing 104, an upper housing 105 and a cleanout tube 106.

According to an embodiment the ring electrodes 101 may be embedded in a matrix to form the heater chamber housing 104. According to an embodiment the matrix may be injection molded around the ring electrodes 101 in order to form the heater chamber housing 104. The matrix or heater chamber housing 104 may comprise a thermo-plastic material such as polyetheretherketone (PEEK).

The first substrate 102 (e.g. PCB) may be connected to the ring electrodes 101 before or after the heater chamber housing 104 has been formed around the ring electrodes 101. One end of the heater chamber housing 104 may be configured for attachment to the upper housing 105 and the other end of the heater chamber housing 104 may be configured for attachment to a cleanout tube 106. A susceptor may be located within the heating chamber housing 104 between the cleanout tube 106 and the upper housing 105.

A shielding material 117 may be provided around an exterior of the ring electrodes 101 in order to prevent the magnetic field generated by the ring electrodes 101 being transmitted radially outwards and hence in the direction of the user. The shielding material 117 may comprise a ferrite material. A thermocouple 113 may be attached to the susceptor in order to measure the temperature of the susceptor.

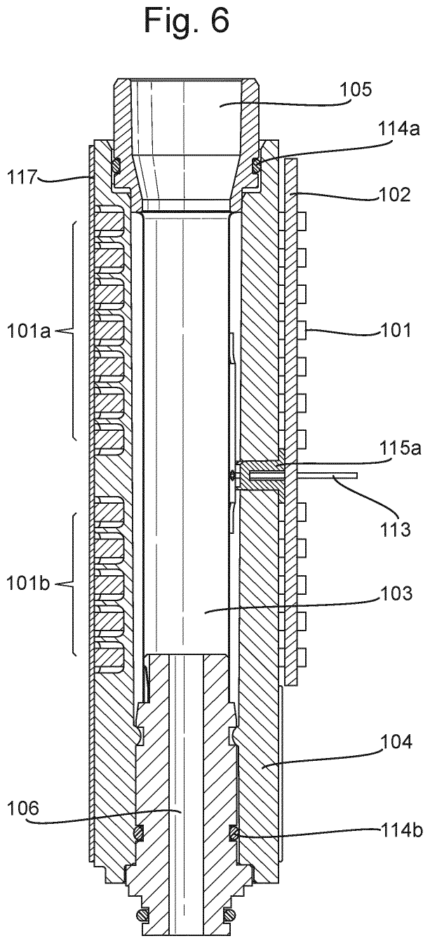

FIG. 6 shows a cross-sectional view of an aerosol generator according to an embodiment. According to an embodiment a first seal 114a may be provided between an upper housing 105 and the heater chamber housing 104. A second seal 114b may be provided between the heater chamber housing 104 and the cleanout tube 106.

The heater chamber housing 104 may be formed with an integral or contiguous upper portion in place of a separate discrete upper housing 105. The upper housing 105 may comprise a thermoplastic material such as polyetheretherketone (PEEK). The heater chamber housing 104 may be formed with a hole or slot into which a thermocouple 113 may be inserted. The thermocouple 113 may be arranged to sense the temperature of the susceptor 103. A seal 115a may be provided to secure the thermocouple 113 within the hole or slot provided in the heater chamber housing 104. The seal 115a may abut a surface of a first substrate 102 which a plurality of ring electrodes 101 are attached thereto.

A shielding material 117 may be provided around an exterior of the ring electrodes 101 in order to attenuate the magnetic field generated by the ring electrodes 101 in a radial direction towards the outer housing of the aerosol provision device. According to various embodiments the shielding material 117 may be provided as an adhesive wrap. The shielding material 117 may comprise a magnetic material such as a ferrite.

The susceptor 103 may be secured within the heater chamber housing 104 by being attached to a cleanout tube 106 at one end and to the upper housing 105 and/or an upper portion of the heater chamber housing 104 at another end. For instance, when the heater chamber housing 104 comprises an integral upper portion 105, the susceptor 103 may be inserted into the heater chamber housing 104 from the opposite end to the upper portion 105. Once the susceptor 103 has been inserted then the cleanout tube 106 may be configured for attachment to an end of the susceptor 103. According to an embodiment the cleanout tube 106 may make a snap fit connection with the susceptor 103 in order to secure the susceptor 103 between the upper portion 105 and the cleanout tube 106. Other embodiments are contemplated wherein the susceptor 103 is held under compression between the upper portion 105 and the cleanout tube 106.

According to an embodiment the cleanout tube 106 may be configured for attachment to the susceptor 103 so that the cleanout tube 106 is first attached to the susceptor 103 before both the susceptor 103 and attached cleanout tube 106 are then inserted together into the heater chamber housing 104 and secured to an upper portion of the heater chamber housing 104.

When a discrete upper housing 105 is provided, the susceptor 103 may be inserted into the heater chamber housing 104 via a bottom portion of the heater chamber housing 104 in a manner as discussed above. Alternatively, the susceptor 103 may be inserted through the top end of the heater chamber housing 104 and then the upper housing 105 may then be secured to (or brought into contact with) the susceptor 103. The upper housing 105 may be configured for attachment to the heater chamber housing 104 using, for example, a compression fit.

According to various embodiments the plurality of ring electrodes 101 may be arranged in one or more groups of electrodes. For example, the aerosol generator may be configured to heat different regions of a susceptor 103 (and hence different regions of an aerosol generating article) to different temperatures. For example, each group of electrodes 101 may be arranged to maintain a corresponding portion of the susceptor 103 at a different temperature during a session of use.

According to an embodiment as shown in FIG. 6, the ring electrodes 101 may be arranged into a first group 101a of ring electrodes and a second group 101b of ring electrodes. In the specific embodiment shown in FIG. 6 the first group 101a of ring electrodes comprises seven ring electrodes 101 and the second group 101b of ring electrodes comprises five ring electrodes 101. However, it will be understood that both the first group of ring electrodes 101a and the second group 101b of ring electrodes may comprise a different number of ring electrodes 101.

It is contemplated that different regions of the susceptor 103 may be maintained at different temperatures during use. This may be achieved by applying different voltages to the first group 101a of ring electrodes to that of the second group 101b of ring electrodes. Other embodiments are contemplated wherein the axial separation (pitch) between the electrodes 101 in the different groups and/or the number of electrodes 101 in the different groups of electrodes may vary. For example, the first group 101a of ring electrodes may have a first axial spacing S1 between electrodes and the second group 101b of ring electrodes may have a second different axial spacing S2 between electrodes. According to an embodiment the first axial spacing S1 may be <1 mm, 1-2 mm, 2-3 mm, 3-4 mm, 4-5 mm, 5-6 mm, 6-7 mm, 7-8 mm, 8-9 mm, 9-10 mm or >10 mm. Similarly, according to an embodiment the second axial spacing S2 may be <1 mm, 1-2 mm, 2-3 mm, 3-4 mm, 4-5 mm, 5-6 mm, 6-7 mm, 7-8 mm, 8-9 mm, 9-10 mm or >10 mm. According to various embodiments, the susceptor may be segmented and thermal barrier portions may separate the segments so that different susceptor segments may be maintained at different temperatures.

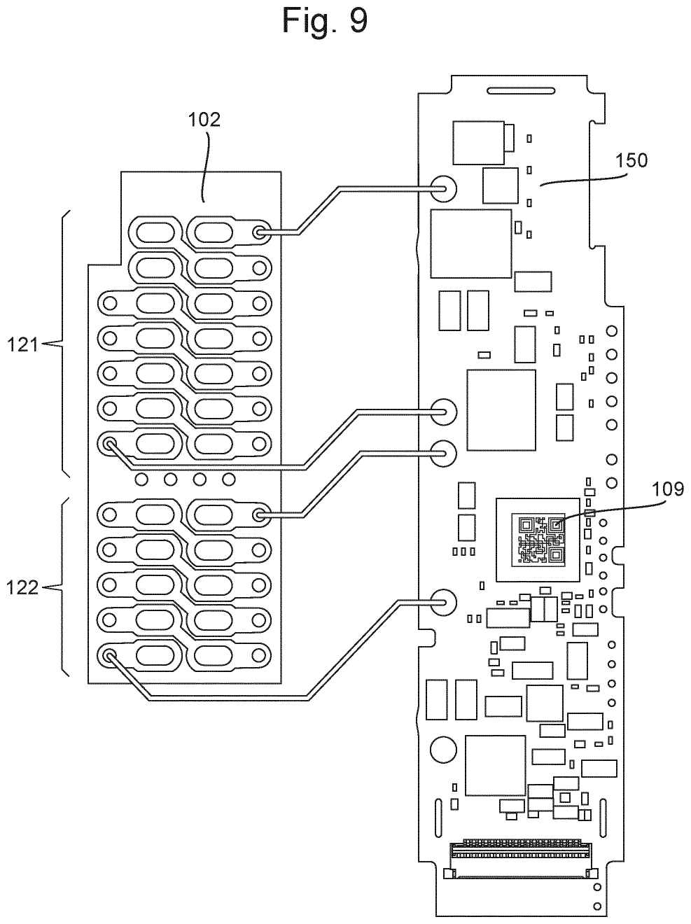

It is contemplated that different temperatures may additionally or otherwise be provided by the aerosol provision device being configured to supply different groups of electrodes 101 with different voltages and/or currents. The aerosol provision device may comprise a control device (as shown and described above in relation to FIG. 1 and as will be described in more detail in relation to FIG. 9) which may be configured to independently apply either one or more AC voltages to groups of ring electrodes 101. This can allow a different voltage to be independently applied to different groups of ring electrodes 101.

For example, the control device may be configured to apply different non-zero voltages to different groups of ring electrodes 101 at the same time and/or to apply a voltage to one or more groups of ring electrodes 101 while applying substantially no voltage to one or more other groups of ring electrodes 101. The control device may be arranged to independently apply either one or more AC voltages to individual ring electrodes 101 in the same group or in different groups.

According to an embodiment the control device may be arranged to supply a first voltage V1 to the first group 101a of ring electrodes and a second voltage V2 to the second group 101b of ring electrodes. According to various embodiment the ratio V1/V2 may be in the range <0.5, 0.5-0.6, 0.6-0.7, 0.7-0.8, 0.8-0.9, 0.9-1.0, 1.0-1.1, 1.1-1.2, 1.2-1.3, 1.3-1.4, 1.4-1.5 or >1.5. The first voltage V1 and the second voltage V2 comprise AC voltages.

According to an embodiment the frequency f1 of the first voltage V1 and the frequency f2 of the second voltage V2 may be different. According to various embodiment the ratio f1/f2 may be in the range <0.5, 0.5-0.6, 0.6-0.7, 0.7-0.8, 0.8-0.9, 0.9-1.0, 1.0-1.1, 1.1-1.2, 1.2-1.3, 1.3-1.4, 1.4-1.5 or >1.5. According to other embodiments the aerosol generator may comprise a single group of ring electrodes 101 and the control device may be arranged to independently apply one or more AC voltages to each of the individual ring electrodes 101.

Maintaining different regions of the susceptor 103 at different temperatures can allow for selectively heating of different portions of an aerosol generating article inserted into the aerosol generator, while not heating other particular portions of the aerosol generating article. For instance, the control device may be configured to apply one or more voltages to a first group 101a of ring electrodes 101 in order to heat a first portion of the aerosol generating article at a first time t1, while not heating a second portion of the aerosol generating article at the same first time t1.

At a second time t2, the control device may be configured to apply one or more voltages to a second group 101b of ring electrodes to heat a second portion of the aerosol generating article, while not heating the first portion of the aerosol generating article at the second time t2.

The control device may additionally or alternatively be configured to apply a particular voltage to a particular group of electrodes to heat one portion of the aerosol generating article to one temperature, and at the same time, to apply a different voltage to a different group of electrodes in order to heat a different portion of the aerosol generating article to a different temperature.

The control device may comprise or consist of a circuit or circuitry. The circuit/circuitry may be programmable and configured by software. According to various embodiments the control device may be located on a first substrate 102 on which a plurality of ring electrodes 101 are mounted or alternatively the control device may be located on a separate substrate e.g. on a separate printed circuit board which may be connected to the first substrate 102.

Each of the groups of ring electrodes 101 may be axially spaced apart from one another. The ring electrodes 101 may be arranged such that planar surfaces of the ring electrodes 101 in different groups are in parallel planes to one another. Each group of electrode(s) 101 may comprise 1, 2, 3, 4, 5, 6, 7, 8, 9, 10, 11, 12, 13, 14, 15, 16, 17, 18, 19, 20 or more than 20 ring electrodes 101.

Embodiments are contemplated wherein the ring electrodes 101 may be grouped into 1, 2, 3, 4, 5, 6, 7, 8, 9, 10 or more than 10 groups of electrodes 101. Each of the groups may comprise the same number or different numbers of ring electrodes 101. Each group of ring electrodes 101 may comprise at least 2, 3, 4, 5, or more than 5 ring electrodes 101. For instance, according to an embodiment the ring electrodes 101 may be arranged into between 2 to 5 groups of ring electrodes 101, wherein each group of ring electrodes 101 comprises at least three ring electrodes 101. The different groups of ring electrode(s) 101 may all be mounted to the same first substrate 102 or alternatively different groups of electrodes 101 may be mounted to different substrates.

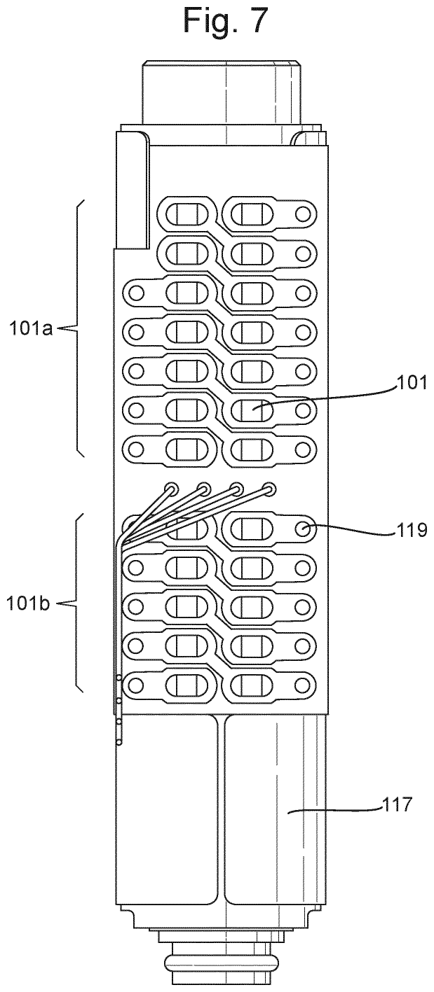

FIG. 7 shows a first substrate having a plurality of electrical connections 119 which are arranged to make contact with a plurality of ring electrodes 101. The ring electrodes and associated electrical connections are shown grouped into a first group 101a of ring electrodes and associated electrical connections provided on the first substrate and a second group 101b of ring electrodes and associated electrical connections provided on the first substrate. A portion of shielding material 117 is also shown.

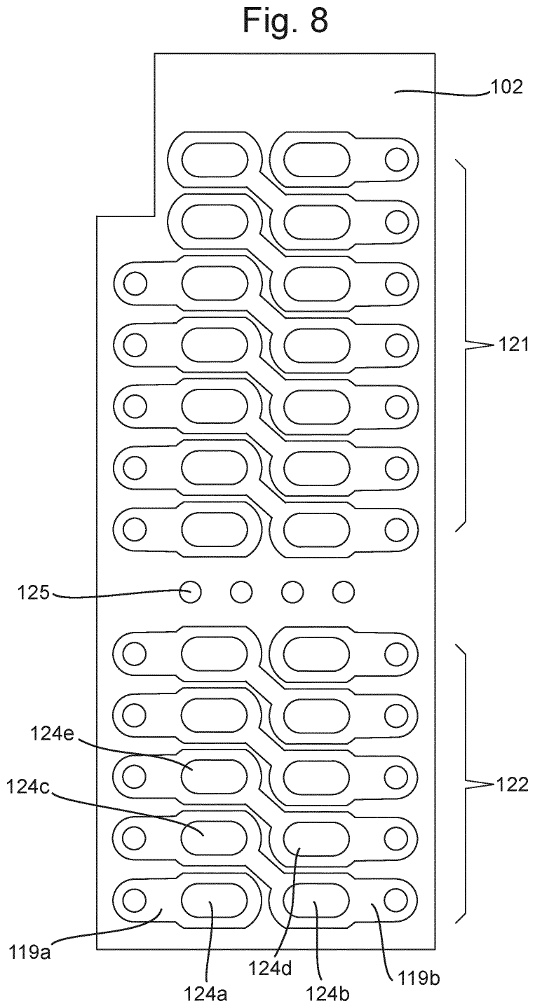

FIG. 8 shows the first substrate 102 in greater detail. The first substrate 102 may comprise a plurality of electrical connections which may be arranged into a first group 121 of electrical connections and a second group 122 of electrical connections. Each electrical connection may comprise at least one slot or aperture 124a, 124b, 124c, 124d, 124e for receiving an electrical connection portion of a ring electrode 101 therein. The electrical connection portions of a ring electrode 101 may be received within two neighbouring slots or apertures 124a, 124b and the ring electrodes 101 may be secured to the slots or apertures 124a, 124b by soldering.

The electrical connections 119a, 119b may be arranged so that within each group 121,122 of electrical connections, a first electrical connection portion of a ring electrode 101 can be received in a slot 124a of one electrical connection 119a and a second electrical connection portion of the same ring electrode 101 can be received in a slot 124b of a different second electrical connection 119b. The second electrical connection 119b may comprise a second slot or aperture 124c for receiving another ring electrode 101 in an axially adjacent position to the ring electrode 101 which is received in slots or apertures 124a, 124b.

The first substrate 102 may therefore be configured to electrically connect axially adjacent ring electrodes 101 such that a voltage applied across electrical connections at opposite axial ends of a group of ring electrodes 101 will cause a current to flow in each of the ring electrodes 101 within the group in a same direction around the longitudinal axis of the ring electrodes 101. It will be understood that an AC voltage may be applied to selected ring electrodes 101 as desired.

However, other embodiments are wherein the coil termination arrangement shown and described with reference to FIGS. 7-9 may be altered so that ring electrodes may be terminated in a different manner to that shown and described with reference to FIGS. 7-9. Embodiments will be described below with reference to FIGS. 10-12 wherein the current in adjacent ring electrodes flows in the opposite direction. In such arrangements instead of the end of a ring electrode provided in slot 124b being electrically connected to the end of a ring electrode provided in slot 124c, instead the end of the ring electrode provided in slot 124b may be electrically connected to the end of a ring electrode directly above it i.e. as provided in slot 124d. Likewise, the end of the ring electrode provided in slot 124c may be electrically connected to the end of a ring electrode directly above it provided in slot 124e.

Other arrangements of the electrical connections to provide this configuration may also be provided. The printed circuit board (“PCB”) substrate 102 may be configured in this manner so as to allow a voltage for generating a varying magnetic field to be applied to each group of electrodes by electrical connections at opposite axial ends of the group.

The first substrate 102 may be arranged for different particular axial separations (pitches) to be set as desired between adjacent ring electrodes 101 based on which electrical connections the ring electrodes 101 are connected to. If there are empty electrical connections between adjacent ring electrodes 101 then solder may be used to connect the electrical connections between adjacent ring electrodes 101.

The first substrate 102 may be arranged for different numbers of groups and/or numbers of electrodes 101 within the groups based on connections between the electrical connections and a control device. One or more additional connections 125 may be provided for electrical connection to other components other than ring electrodes 101 such as a temperature sensor or other type of sensor.

FIG. 9 shows a control device 109 which may be connected to the first substrate 102 according to various embodiments. The control device 109 may be provided on a second PCB substrate 150 which is connected to the first substrate 102. However, other embodiments are contemplated wherein all or part of the control device 109 may instead be provided on the same first substrate 102 that the ring electrodes 101 are mounted to. Electrical connections may be provided between the control device 109 and electrical connections at opposite axial ends of each of the groups of electrical connections 121,122. This allows the control device 109 to independently apply voltages to the groups of electrodes 101 via the electrical connections at opposite axial ends of each of the groups 121, 122 of electrical connections.

According to various embodiments an AC voltage may be arranged to be supplied or applied to a first group of electrodes connected to first electrical connections 121 under the control of the control device 109 so that all the electrodes in the first group of electrodes connected to the first electrical connections 121 are simultaneously supplied with an AC voltage. Similarly, an AC voltage may be arranged to be supplied or applied to a second group of electrodes connected to second electrical connections 122 under the control of the control device 109 so that all the electrodes in the second group of electrodes connected to the second electrical connections 122 are simultaneously supplied with an AC voltage. Accordingly, an aerosol generator is provided comprising two heating zones which may be controlled independently.

FIG. 10 shows a schematic of an electronic component 126 of an aerosol generator according to various embodiments. The component may be incorporated into an aerosol provision device. The component 126 comprises an inductor element 127 comprising a plurality of discrete ring electrodes L1-L12. The component further comprises a first module 128 arranged to receive a DC voltage and to output an alternating current (AC). The component 126 also comprises a second module 129 which is arranged to supply or switch the alternating current to selected ones of the ring electrodes L1-L12.

Each of the ring electrodes L1-L12 is shown schematically in FIG. 10 as an inductor. The electrodes L1-L12 may comprise ring electrodes as described above. For example, the electrodes L1-L12 may be planar and may be mounted to a substrate (not shown) such as a printed circuit board (“PCB”).

According to an embodiment the ring electrodes L1-L12 may be arranged in two groups of electrodes. For example, the ring electrodes L1-L12 may be arranged to form a first group of electrodes comprises ring electrodes L1-L7 and a second group of electrodes comprises ring electrodes L8-L12. The ring electrodes within the same group may be connected in series with one another but are not connected in series with the ring electrodes of the other group.

The first module 128 may be arranged to generate an alternating current in any suitable manner. For example, the first module 128 may comprise a half-bridge driver 128a that comprises two MOSFET (Metal-Oxide-Semiconductor Field-Effect Transistor) switches 130a, 130b and a MOSFET driver 131 connected to the respective gate terminals of the MOSFET switches 130a, 130b for controlling the MOSFET switches 130a, 130b.

A first MOSFET switch 130a may connected to a DC voltage input (e.g. 6 V) and a second MOSFET switch 130b may be connected to a common/ground terminal. The MOSFET driver 131 may be arranged to toggle the MOSFET switches 130a, 130b in order to output an alternating current. The first module 128 may further comprise a power controller 132 which may be arranged to supply a signal (e.g. a regular periodic signal or clock signal) to the MOSFET driver 131 in order to control when the MOSFET switches 130a, 130b are toggled and hence determine the frequency of the alternating current which is output. The alternating current signal generated by the first module 128 may be supplied to the second module 129 via an AC power rail 133. According to an embodiment the AC voltage which is supplied via AC power rail 133 may have a 3V DC offset. Accordingly, the AC voltage according to various embodiments may oscillate between 0V and 6V.

The second module 129 may comprise a first plurality of (e.g. ten) semiconductor switches 134a and a second plurality of (e.g. twelve) semiconductor switches 134b. The first plurality of semiconductor switches 134a are connected to a switch controller 136, the AC power rail 133 and a first end of at least some (e.g. ten) of the ring electrodes L3-L12. The second plurality of semiconductor switches 134b are connected to a second end of the (e.g. twelve) ring electrodes L1-L12 via a capacitor 135, a common/ground terminal(s) 137 and the switch controller 136. According to various embodiments the second module 129 may comprise the control device 109 as described above with reference to FIGS. 1 and 9.

According to various embodiments the first semiconductor switches 134a comprise switches connected between the inductor element 127 (which includes ring electrodes L1-L12) and the AC power rail 133 and the second conductor switches 134b are connected between the inductor element 127 (which includes ring electrodes L1-L12) and common/ground terminal(s) 137. Capacitors 135 are connected in series with the ring electrodes L1-L12 and together form a RLC (resistor-inductor-capacitor) or LC (inductor-capacitor) circuit with a ring electrode forming the inductor. The capacitors 135 may be configured in order to set (e.g. reduce) the resonant frequency for optimal driving of the ring electrodes L1-L12. The capacitance of the capacitors 135 may be the same. Alternatively, some capacitors 135 may have a different capacitance. The switch controller 136 may be arranged to control the first plurality of semiconductor switches 134a and the second plurality of semiconductor switches 134b so as to cause only particular (selected) ring electrodes L1-L12 to receive power from the AC power rail 133 at a particular time. Thus, the switch controller 136 can control which ring electrodes L1-L12 are supplied with an alternating current or voltage. This can be used to provide a selected heating profile.

The semiconductor switches 134a, 134b may comprise a switching arrangement. For example, the switching arrangement may comprise a pair of MOSFETs.

As will be discussed in more detail below, the susceptor element may be segmented in a series of segments. For example, each segment may comprise a portion of the susceptor element which is immediately proximal to one of the ring electrodes L1-L12.

With the specific example of the embodiment shown in FIG. 10 comprising twelve ring electrodes L1-L12, the susceptor element may be arranged so as to comprise twelve segments which can each be independently controlled. The susceptor element may be configured to include a thermal barrier between segments. According to various embodiments during a session of use lasting e.g. 3-6 mins, a first susceptor segment may be arranged to be maintained at a temperature T1 in the range 20-400° C., a second susceptor segment may be arranged to be maintained at a temperature T2 in the range 20-400° C., a third susceptor segment may be arranged to be maintained at a temperature T3 in the range 20-400° C., a fourth susceptor segment may be arranged to be maintained at a temperature T4 in the range 20-400° C., a fifth susceptor segment may be arranged to be maintained at a temperature T5 in the range 20-400° C., a sixth susceptor segment may be arranged to be maintained at a temperature T6 in the range 20-400° C., a seventh susceptor segment may be arranged to be maintained at a temperature T7 in the range 20-400° C., an eighth susceptor segment may be arranged to be maintained at a temperature T8 in the range 20-400° C., a ninth susceptor segment may be arranged to be maintained at a temperature T9 in the range 20-400° C., a tenth susceptor segment may be arranged to be maintained a temperature T10 in the range 20-400° C., an eleventh susceptor segment may be arranged to be maintained at a temperature T11 in the range 20-400° C. and a twelfth susceptor segment may be arranged to be maintained a temperature T12 in the range 20-400° C. Accordingly, with regards the example shown in FIG. 10 a controller may be arranged to set a susceptor element a desired spatial heating profile wherein at least some or all of the susceptor segments may be maintained at different temperatures at any instant in time. For example, the controller may be arranged to set a heating profile wherein T1≠T2≠T3≠T4≠T5≠T6≠T7≠T8≠T9≠T10≠T11≠T12. Embodiments are contemplated wherein the inductor element 127 comprises 2, 3, 4, 5, 6, 7, 8, 9, 10, 11, 12, 13, 14, 15, 16, 17, 18, 19, 20, 21, 22, 23, 24, 25, 26, 27, 28, 29, 30 or >30 ring electrodes. Similarly, embodiments are contemplated wherein the susceptor element comprises 2, 3, 4, 5, 6, 7, 8, 9, 10, 11, 12, 13, 14, 15, 16, 17, 18, 19, 20, 21, 22, 23, 24, 25, 26, 27, 28, 29, 30 or >30 segments. At least some or all of the segments of the susceptor element may be separated from each other by a thermal barrier such as a potting compound, an adhesive, a thermosetting plastic or an epoxy resin.

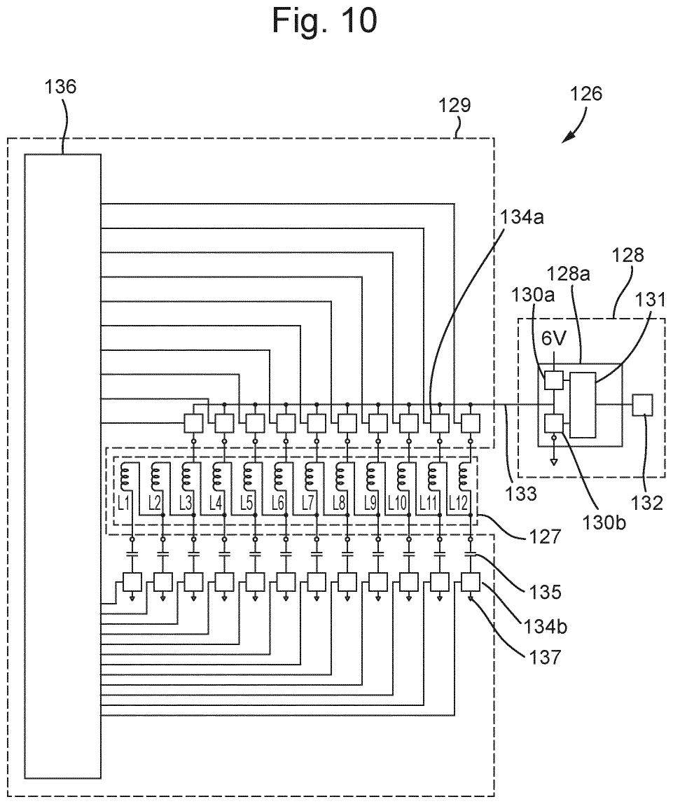

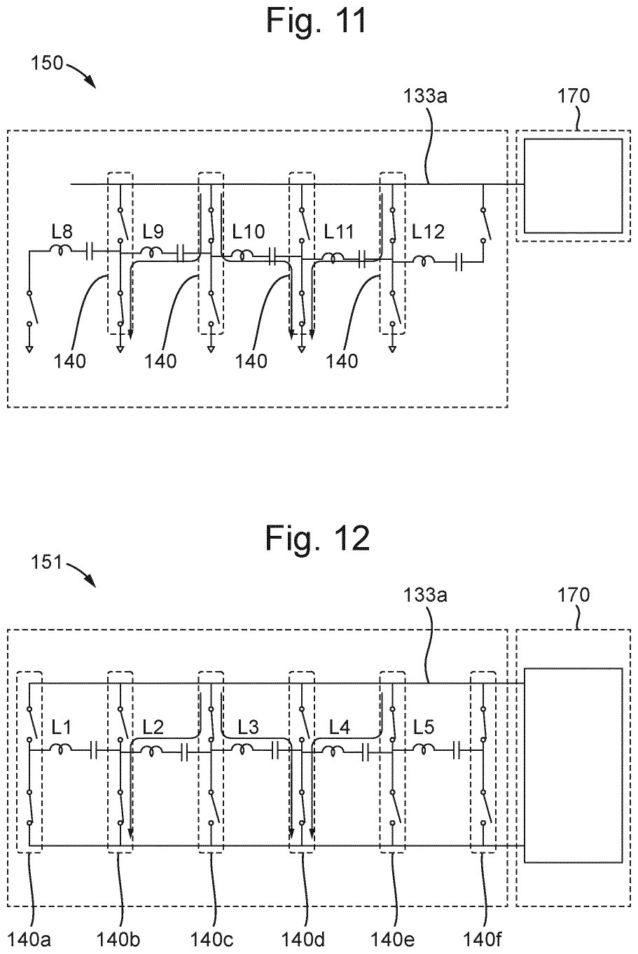

FIG. 11 shows a schematic of an electrical arrangement 150 for a component of an aerosol generator or aerosol provision device in accordance with various embodiments. FIG. 11 illustrates how the electrical arrangement 150 may be used to toggle a DC voltage to a group of ring electrodes such as, in the particular example shown, ring electrodes L8-L12 as shown and described above with regards the arrangement shown in FIG. 10. However, it will be understood that the electrical arrangement 150 is suitable more generally for applying a DC voltage which reverses direction through a plurality of ring electrodes.

With the arrangement shown and described with reference to FIG. 10 an AC voltage was selectively switched to desired ring electrodes e.g. by a switching arrangement. In contrast, the arrangement disclosed with reference to FIG. 11 illustrates how a DC voltage from a DC power rail 133a may be selectively switched to one or more of the ring electrodes L8-L12 by virtue of an array of half-bridge circuits 140. Each half-bridge circuit 140 comprises a first or upper MOSFET switch and a second or lower MOSFET switch. The first or upper MOSFET switches are connected to the DC power rail 133a and the second or lower MOSFET switches are connected to common/ground. A capacitor may be provided in series with each ring electrode. According to various embodiments the capacitor may be mounted on a printed circuit board (PCB) to which the ring electrodes L8-L12 are also mounted. Each ring electrode L8-L12 and corresponding capacitor forms a resonant circuit. According to various embodiments in order to create magnetic flux around a ring electrode L8-L12 or conductive loop, two half-bridge circuits 140 are switched ON-OFF in a diagonally complementary pattern.

The DC voltage provided to the DC power rail 133a may be controlled by a first DC power module 170.

FIG. 12 shows a schematic of an electrical arrangement 151 for a component of an aerosol generator or aerosol provision device in accordance with another embodiment. FIG. 12 illustrates how the electrical arrangement 151 may be used to apply an AC voltage to a group of five ring electrodes L1-L5.

According to various embodiments an DC voltage from a DC power rail 133a may be selectively switched to one or more of the ring electrodes L1-L5 by virtue of an array of six half-bridge circuits 140a-f. Each half-bridge circuit 140a-f comprises a first MOSFET switch and a second MOSFET switch. The first MOSFET switches are connected to the DC power rail 133a and the second MOSFET switches are connected to common/ground. Each ring electrode L1-L5 is connected in series with a capacitor. According to various embodiments the capacitor may be mounted on a printed circuit board (PCB) to which the ring electrodes L1-L5 are also mounted. Each ring electrode L1-L5 and corresponding capacitor forms a resonant circuit. According to various embodiments in order to create magnetic flux around a ring electrode L1-L5 or conductive loop, two half-bridge circuits 140a-f are switched ON-OFF in a diagonally complementary pattern.

The DC voltage provided to the DC power rail 133a may be controlled by a DC power module 170.

Selective heating of individual susceptor element segments is possible. For example, in order to heat susceptor element segments corresponding to ring electrodes L2, L3 and L4, second, third, fourth and fifth half-bridge circuits 140b, 140c, 140d, 140e are switched ON-OFF in a diagonally complementary pattern so that a DC voltage from the DC power rail 133a is initially caused to pass through ring electrodes L2, L3 and L4 in a first direction and before the current switches direction and passes through the ring electrodes L2, L3 and L4 in a second direction with is opposed to the first direction. As a result, an AC voltage is applied to the ring electrodes L2, L3 and L4. According to various embodiments the first half-bridge circuit 140a may be switched in a coordinated manner with the second half-bridge circuit 140b. Similarly, the sixth half-bridge circuit 140f may be switched in a coordinated manner with the fifth half-bridge circuit 140e. As a result, a zero voltage loop is formed which prevents current flow in e.g. the first ring electrode L1.

According to various embodiments only two MOSFET switching elements are required per ring electrode L1-L5 (or per ring electrode L3-L12 in the embodiment shown and described with reference to FIG. 10) together with an extra two MOSFETs. This is in contrast with other arrangements wherein e.g. four MOSFETs may be provided in a full H-bridge arrangement in order to drive a current or voltage through e.g. an inductor coil. As a result, the electronic circuit according to various embodiments utilizes a reduced number of MOSFETs which enables the electronic components to be provided on a printed circuit board having a reduced footprint. This enables a more compact aerosol provision device to be provided. It will also be appreciated that cost of production can be reduced. According to various embodiments, the various electronic components can be provided in a driver unit wherein the electronic components are configured in a space efficient manner as a single integrated circuit (IC).

It will be understood that selective heating of susceptor element segments according to various embodiments may be achieved by parallel connection of multiple independently controlled loops or ring electrodes. Improved system controllability may be achieved by utilizing a relatively high series capacitance/capacitor in order to reduce the resonant frequency of each ring electrode. For reference purposes, an inductor coil comprising 7 turns may have an inductance of approx. 400 nH and may be provided in series with a 100 nF capacitor to provide an inductor element having a resonant frequency of approx. 1 MHz. According to various embodiments each ring electrode may have an inductance of approx. 50 nH and may be provided in series with e.g. a 1 μF capacitor so that the resonant frequency of the ring electrode is approx. 1 MHz.

However, other embodiments are also contemplated. According to other embodiments the inductance of each ring electrode may be <1 nH, 1-10 nH, 10-20 nH, 20-30 nH, 30-40 nH, 40-50 nH, 50-60 nH, 60-70 nH, 70-80 nH, 80-90 nH, 90-100 nH. The capacitance of a capacitor provided in series with each ring electrode may be <100 nF, 100-200 nF, 200-300 nF, 300-400 nF, 400-500 nF, 500-600 nF, 600-700 nF, 700-800 nF, 800-900 nF, 900-1000 nF, 1-2 μF, 2-3 μF, 3-4 μF, 4-5 μF, 5-6 μF, 6-7 μF, 7-8 μF, 8-9 μF, 9-10 μF, 10-11 μF, 11-12 μF, 12-13 μF, 13-14 μF, 14-15 μF, 15-16 μF, 16-17 μF, 17-18 μF, 18-19 μF, 19-20 μF or >20 μF.

The resonant frequency of at least some or each ring electrode may be arranged to be <10 kHz, 10-100 kHz, 100-200 kHz, 200-300 kHz, 300-400 kHz, 400-500 kHz, 500-600 kHz, 600-700 kHz, 700-800 kHz, 800-900 kHz or 900-1000 kHz. According to other embodiments the resonant frequency of at least some or each ring electrode may be arranged to be 1.0-1.1 MHz, 1.1-1.2 MHz, 1.2-1.3 MHz, 1.3-1.4 MHz, 1.4-1.5 MHz, 1.5-1.6 MHz, 1.6-1.7 MHz, 1.7-1.8 MHz, 1.8-1.9 MHz, 1.9-2.0 MHz, 2.0-2.1 MHz, 2.1-2.2 MHz, 2.2-2.3 MHz, 2.3-2.4 MHz, 2.4-2.5 MHz, 2.5-2.6 MHz, 2.6-2.7 MHz, 2.7-2.8 MHz, 2.8-2.9 MHz, 2.9-3.0 MHz, 3.0-3.1 MHz, 3.1-3.2 MHz, 3.2-3.3 MHz, 3.3-3.4 MHz, 3.4-3.5 MHz, 3.5-3.6 MHz, 3.6-3.7 MHz, 3.7-3.8 MHz, 3.8-3.9 MHz, 3.9-4.0 MHz, 4.0-4.1 MHz, 4.1-4.2 MHz, 4.2-4.3 MHz, 4.3-4.4 MHz, 4.4-4.5 MHz, 4.5-4.6 MHz, 4.6-4.7 MHz, 4.7-4.8 MHz, 4.8-4.9 MHz or 4.9-5.0 MHz. According to other embodiments the resonant frequency of at least some or each ring electrode may be arranged to be 5-10 MHz, 10-20 MHz, 20-30 MHz, 30-40 MHz, 40-50 MHz, 50-60 MHz, 60-70 MHz, 70-80 MHz, 80-90 MHz, 90-100 MHz or >100 MHz.

With regard the coil termination arrangement shown and described above with reference to FIGS. 7-9, it will be understood that when a control system as described above with reference to FIGS. 10-12 is implemented then the coils may be terminated in a different manner to that shown and described with reference to FIGS. 7-9. It will be stood that with the implementation shown and described with reference to FIGS. 10-12 then the current in adjacent ring electrodes flows in the opposite direction. For example, whereas in the arrangement shown in FIG. 8 the end of a ring electrode provided in slot 124b is shown being electrically connected to the end of a ring electrode provided in slot 124c, instead according to various embodiments the end of the ring electrode provided in slot 124b may be electrically connected to the end of a ring electrode directly above it which is provided in slot 124d. Likewise, the end of the ring electrode provided in slot 124c may be electrically connected to the end of a ring electrode directly above it which is provided in slot 124e.

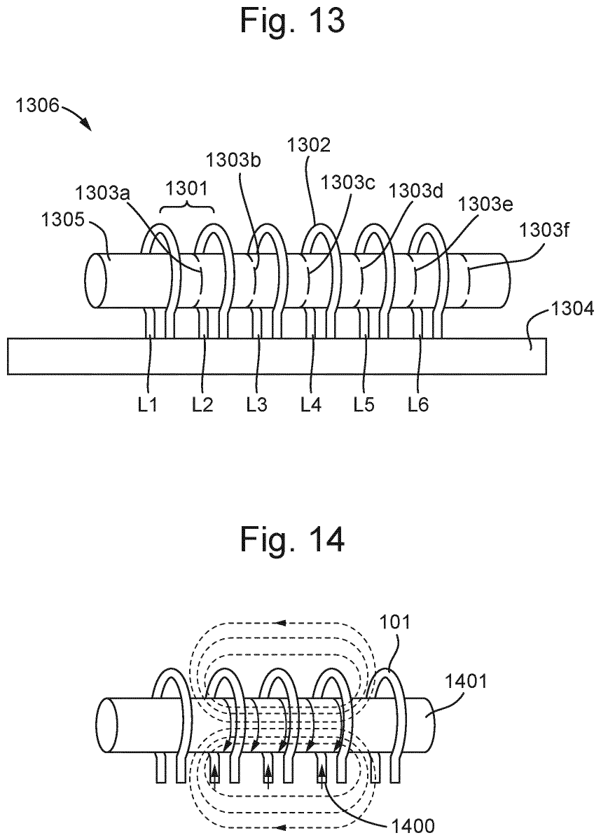

FIG. 13 illustrates an aerosol generator 1306 according to an embodiment comprising six ring electrodes L1-L6 or conductive loops 1302 and a tubular susceptor element 1305 located within a volume defined by the ring electrodes or conductive loops 1302. The ring electrodes or conductive loops 1302 are mounted to a printed circuit board (“PCB”) 1304. A plurality of segments 1301 are provided between adjacent ring electrodes or conductive loops 1302. According to various embodiment one or more circumferential slots 1303a-1303f may be provided in the susceptor element 1305 in order to reduce thermal bleed. For example, if it is desired to apply an AC voltage to the first ring electrode LI then a corresponding current may be induced in a corresponding segment of the tubular susceptor element 1305 located in close proximity to the first electrode L1. As a result, that segment of the tubular susceptor element 1305 may quickly attain a temperature T1 e.g. 250-350° C. However, a neighbouring segment of the tubular susceptor element 1305 may be desired to be maintained at a lower temperature e.g. 20-250° C. It will be understood that if the tubular susceptor element 1305 comprises a continuous non-segmented tubular element then heat energy transmitted to a section of the susceptor element 1305 will be quickly transmitted to the whole of the tubular element by conduction. As a result, the whole of the tubular element would quickly assume substantially the same temperature.

However, according to various embodiments, one or more circumferential slots 1303a-1303f may be provided in the susceptor element 1305. The one or more circumferential slots 1303a-1303f provide a thermal barrier or a partial thermal barrier to reduce the transmission of heat energy between adjacent segments of the susceptor element 1305 by thermal conduction.

The one or more circumferential slots 1303a-1303f may be at least partially filled with a thermally insulating material. The thermally insulating material may comprise a potting compound, an adhesive, thermosetting plastic or an epoxy resin. According to various embodiments the potting compound may comprise an epoxy resin. For example, a two-component epoxy may be used consisting of a polymer resin and a hardener which when mixed together causes a chemical reaction which cross-links chemical bonds in the polymer chains to create a tough, rigid and strong compound. Other embodiments are contemplated wherein the potting compound comprises a polyurethane (“PU”) e.g. a thermoset plastic. This may comprise a two-component compound consisting of a base resin with an isocyanate curing agent. Other embodiments are contemplated wherein the potting compound comprises a silicone. For example, silicone rubber may be utilized comprising a synthetic polysiloxane polymer that uses an additive catalyser (such as platinum) to transition from a liquid to a solid state.

FIG. 14 illustrates the direction of flow 1400 of current around multiple ring electrodes 101 according to an embodiment and the resulting magnetic field. A tubular susceptor element 1401 is shown located within the ring electrodes 101. The susceptor element 1401 may comprise a plurality of susceptor element segments with thermal barrier portions provided between the susceptor element segments.

According to various embodiments an aerosol generator is disclosed comprising a plurality of ring electrodes. The ring electrodes may be arranged to form a plurality of independently controllable heating zones. A control device may be arranged to independently energise the ring electrodes. For example, a two zone heating profile may be utilized. Other embodiments are contemplated wherein more complex heating profiles may be utilized. For example, according to an embodiment a heating profile may be utilized wherein segmented susceptor elements are progressively energised so that in effect a heating profile is translated along at least a portion of the length of the aerosol generator during a session of use. For example, the control device may be arranged to apply an AC voltage to either individual ring electrodes and/or groups of ring electrodes in a sequential manner or according to a predetermined order. The aerosol provision device may comprise an opening for receiving an aerosol generating article, wherein a first heating zone is arranged proximal the opening and one or more further heating zones are arranged distal to the opening. The control device may be arranged either: (i) to translate the heating profile from the first heating zone towards the one or more further heating zones during a session of use; and/or (ii) to translate the heating profile from the one or more heating zones towards the first heating zone during a session of use.

Embodiments are contemplated wherein the aerosol generator comprises 3, 4, 5, 6, 7, 8, 9, 10 or more than 10 independently controllable heating zones and wherein a heating profile may be translated between or along the different heating zones.

According to various embodiments an electronic component of an aerosol provision device is provided comprising an inductor element comprising a plurality of discrete electrodes mounted to a substrate. The electrodes may comprise ring or planar electrodes having a single loop. The electronic component may comprise a first module which is configured to receive a DC voltage and to output an alternating current. The first module may comprise a DC-to-AC converter (or DC-AC inverter) comprising a half-bridge or full H-bridge to convert e.g. a DC into an AC current or voltage. According to an embodiment the first module may comprise two MOSFETs forming a half-bridge circuit in combination with a MOSFET driver. The electronic component may further comprise a second module arranged to supply the alternating current to selected electrodes. The second module may comprise a plurality of semiconductor switches. According to embodiments an AC current or voltage from an AC power rail may be individually switched to a plurality of electrodes e.g. ring electrodes by a switching element. Each electrode or ring electrode may be provided with a switching element. The switching element may comprise two MOSFETs. The electrodes e.g. ring electrodes may be mounted to a printed circuit board (PCB) and each electrode may be connected in series with a relatively high capacitance capacitor e.g. 1 μF. As a result, the resultant resonant frequency of each individual ring electrode may be arranged to be approx. 1-2 MHz. According to an embodiment the resonant frequency of each individual ring electrode may be arranged to be 1.0-1.2 MHz, 1.2-1.4 MHz, 1.4-1.6 MHz, 1.6-1.8 MHz or 1.8-2.0 MHz.

Although embodiments have been described above wherein a susceptor element, which may be segmented, is provided as part of an aerosol generator (which in turn forms part of an overall aerosol provision device), embodiments are also contemplated wherein a susceptor element may be provided instead as part of an aerosol generating article comprising aerosol generating material i.e. consumable. For example, according to embodiments an aerosol generating article may be provided comprising a susceptor element. The susceptor element may, for example, comprise a planar stainless steel element. The planar stainless steel element may have a nickel coating. The nickel coating may have a Curie temperature of approx. 354° C. whereas the stainless steel element may comprise 430 stainless steel which comprises 0% nickel. The Curie temperature of 430 stainless steel is >400° C. When the nickel coating reaches the Curie temperature of approx. 354° C. the nickel coating undergoes a reversible change from ferromagnetic phase to paramagnetic phase. The susceptor may be segmented with a thermal barrier portion as discussed above provided between neighbouring segments.

As the susceptor is heated up to around 350° C. (i.e. below the Curie temperature of nickel) then the apparent resistance will increase. This increase in resistance can be detected by measuring the DC current drawn from a DC power source which is supplied to a DC-to-AC converter (or DC-AC inverter). The output from the DC-to-AC converter (or DC-AC inverter) comprises an AC voltage which is supplied to the electrodes forming the inductor element. As will be understood by those skilled in the art, if the voltage supplied to the DC-to-AC converter (or DC-AC inverter) is kept constant (e.g. 6V) and the apparent resistance increases with increasing temperature then the DC current will decrease.

It will be understood that a high frequency alternating magnetic field will induce eddy currents in close proximity to the surface of the susceptor. This effect is known as the skin effect. The resistance in the susceptor depends in part on the depth of the skin layer available for induced eddy currents. As the nickel layer reaches its Curie temperature then it loses its magnetic properties. This causes an increase in the skin layer available for eddy currents in the nickel layer which causes a decrease in the apparent resistance of the susceptor. As a result, a temporary increase in the detected DC current may be observed as the nickel layer reaches its Curie temperature. Accordingly, monitoring of the DC current drawn by the DC power source enables a known temperature (e.g. 354° C.) to be able to be determined.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilized and modifications may be made without departing from the scope of the claimed invention. Various embodiments of the invention may suitably comprise, consist of, or consist essentially of, appropriate combinations of the disclosed elements, components, features, parts, steps, means, etc, other than those specifically described herein. In addition, this disclosure may include other inventions not presently claimed, but which may be claimed in future.

1. An aerosol provision device comprising:
an aerosol generator comprising an inductor comprising a plurality of discrete ring electrodes mounted to a first substrate.

2. An aerosol provision device as claimed in claim 1, wherein the first substrate comprises a first printed circuit board (“PCB”).

3. An aerosol provision device as claimed in claim 1, wherein the ring electrodes are planar.

4. An aerosol provision device as claimed in claim 1, wherein the ring electrodes are embedded in a matrix to form a housing.

5. (canceled)

6. (canceled)

7. An aerosol provision device as claimed in claim 1, further comprising:
a control device arranged to independently apply either one or more AC voltages to either individual ring electrodes and/or to groups of ring electrodes.

8. An aerosol provision device as claimed in claim 1,
wherein the ring electrodes are arranged to form a plurality of independently controllable heating zones; and
the aerosol provision device further comprises a control device arranged to independently energize the ring electrodes so that a heating profile is translated along at least a portion of the length of the aerosol generator during a session of use.

9. An aerosol provision device as claimed in claim 8, wherein the control device is arranged to apply an AC voltage to either individual ring electrodes and/or groups of ring electrodes in a sequential manner or according to a predetermined order.

10. An aerosol provision device as claimed in claim 8, wherein the aerosol provision device comprises an opening for receiving an aerosol generating article, wherein a first heating zone is arranged proximal the opening and one or more further heating zones are arranged distal to the opening and wherein the control device is arranged either: (i) to translate the heating profile from the first heating zone towards the one or more further heating zones during a session of use; and/or (ii) to translate the heating profile from the one or more further heating zones towards the first heating zone during a session of use.

11. A component as claimed in claim 28, wherein said module is a second module, and the component further comprises:
a first module arranged to receive a DC voltage and to output the alternating current.

12. A component as claimed in claim 11, wherein the second module comprises a plurality of electronic switching elements, at least one electronic switching element is connected to at least some of the ring electrodes, and at least some of the switching elements are independently controllable so that the alternating current output from the first module may be applied to selected ring electrodes.

13. (canceled)

14. (canceled)

15. A component as claimed in claim 12, wherein at least some or each of the switching elements comprise a half-bridge circuit.

16. A component as claimed in claim 15, wherein at least some or each half-bridge circuit comprises two MOSFETs.

17. (canceled)

18. A component as claimed in claim 28, wherein the component is an aerosol generator.

19. (canceled)

20. (canceled)

21. A component as claimed in claim 28, further comprising a controller, wherein the controller is arranged to control the module in order to control which ring electrodes are supplied with the alternating current.

22. A component as claimed in claim 28, further comprising a tubular susceptor located at least partially within a volume defined by the plurality of ring electrodes.

23. A component as claimed in claim 22, wherein the tubular susceptor comprises one or more circumferential slots.

24. A component as claimed in claim 22, wherein the tubular susceptor comprises a plurality of annular susceptor portions, wherein at least some of the annular susceptor portions are separated from each other by one or more thermal barrier portions.

25. (canceled)

26. A method of generating an aerosol comprising:
providing an aerosol provision device comprising an aerosol generator that comprises an inductor comprising a plurality of discrete ring electrodes mounted to a substrate;
at least partially inserting an aerosol generating article into the aerosol provision device; and
activating the aerosol provision device.

27. An aerosol provision device as claimed in claim 1, wherein each ring electrode comprises two electrical connection portions inserted into holes or slots provided in the first substrate, the ring electrodes are electrically connected to the first substrate via the electrical connection portions, and the ring electrodes are supported by the first substrate via the electrical connection portions.

28. A component of an aerosol provision device comprising:
an inductor element comprising a plurality of discrete ring electrodes mounted to a substrate; and
a module arranged to supply an alternating current to selected ring electrodes.
